(19) United States
(12) Patent Application Publication
(10) Pub. No.: US 2026/0180937 A1
(43) Pub. Date: Jun. 25, 2026

(54) INFORMATION PROCESSING APPARATUS, INFORMATION PROCESSING METHOD, AND NON-TRANSITORY COMPUTER READABLE STORAGE MEDIUM

(71) Applicant: CANON KABUSHIKI KAISHA, Tokyo (JP)

(72) Inventor: KAZUYA MORIOKA, Tokyo (JP)

(21) Appl. No.: 19/427,892

(22) Filed: Dec. 19, 2025

(30) Foreign Application Priority Data
Dec. 24, 2024 (JP) 2024-227348

(51) Int. Cl. H04L 51/04; H04L 51/216; H04L 51/56

(52) U.S. Cl. CPC H04L 51/04; H04L 51/216; H04L 51/56

(57) ABSTRACT

A non-transitory computer readable storage medium storing a computer program that executes a method that includes receiving a selection of a channel to which a message written in a chat is to be transferred, and displaying, on a screen of the selected channel, the message transferred to the selected channel, wherein, on the screen of the channel on which the transferred message is displayed, an object by which the message is identifiable as a transferred message is displayed.

### BACKGROUND

### Field of the Technology

The present disclosure relates to information processing technology for providing a chat service.

### Description of the Related Art

In recent years, chat services that enable users to share messages posted one-on-one or in groups of three or more have become widely popular. In particular, chatting in groups of three or more (group chat) enables sharing the same message with all members in a single post or to see all other members'posts in a single chat room.

Since a group chat has all the members'posts in one place, if one person, for example, posts a message to contact or ask another member, many replies will be posted in one chat room, which reduces the visibility of the message. In Japanese Patent Laid-Open No. 2017-041236, each member's reply to a message to the entire group (group message) is displayed for each group message, separately from the chat room where all messages in the group chat are posted. In Japanese Patent Laid-Open No. 2017-041236, the messages displayed for each group message are displayed with metadata such as the submitter and date and time of posting retained, and visibility is not deteriorated.

The technology described in Japanese Patent Laid-Open No. 2017-041236 has a problem that the messages that can be displayed in another chat room while retaining metadata are limited to group messages and reply messages that the processor identifies as having been sent as a reply to those messages.

### SUMMARY

The present disclosure relates to a non-transitory computer readable storage medium storing a computer program that executes a method, the method including receiving a selection of a channel to which a message written in a chat is to be transferred, and displaying, on a screen of the selected channel, the message transferred to the selected channel, wherein, on the screen of the channel on which the transferred message is displayed, an object by which the message is identifiable as a transferred message is displayed.

Features of the present disclosure will become apparent from the following description of embodiments with reference to the attached drawings. The following description of embodiments is described by way of example.

### BRIEF DESCRIPTION OF THE DRAWINGS

FIG. 1 is a system configuration diagram illustrating the entire system according to the present disclosure.

FIG. 2 is a block diagram illustrating an example hardware configuration of a client terminal and a chat tool server.

FIG. 3A is a block diagram illustrating an example software configuration of a client terminal.

FIG. 3B is a block diagram illustrating an example software configuration of a chat tool server.

FIG. 4 is a flowchart illustrating a process of creating a new thread according to a first embodiment.

FIG. 5A is a diagram illustrating an example of a channel screen displayed when a chat application is executed on a client terminal according to the first embodiment.

FIG. 5B is a diagram illustrating an example of a chat room screen displayed when a chat application is executed on a client terminal according to the first embodiment.

FIG. 6 is a flowchart illustrating a process of creating a new thread according to a second embodiment.

FIG. 7A is a diagram illustrating an example of a channel screen and chat room screen displayed when a chat application is executed on a client terminal according to the second embodiment.

FIG. 7B is a diagram illustrating an example of a chat room screen displayed when a chat application is executed on a client terminal according to the second embodiment.

FIG. 8 is a flowchart illustrating a process of generating a chat message data based on message information according to a third embodiment.

FIG. 9A is a diagram illustrating an example of a channel screen displayed when a chat application is executed on a client terminal according to the third embodiment.

FIG. 9B is a diagram illustrating an example of a channel screen displayed when a chat application is executed on a client terminal according to the third embodiment.

FIG. 10 is a flowchart illustrating a process of obtaining chat message information based on message information on a selected chat according to a fourth embodiment.

FIG. 11A is a diagram illustrating an example of a chat room screen displayed when a chat application is executed on a client terminal according to the fourth embodiment.

FIG. 11B is a diagram illustrating an example of a chat room screen displayed when a chat application is executed on a client terminal according to the fourth embodiment.

### DESCRIPTION OF THE EMBODIMENTS

The embodiments for carrying out the present disclosure will be described below with reference to the drawings.

### First Embodiment

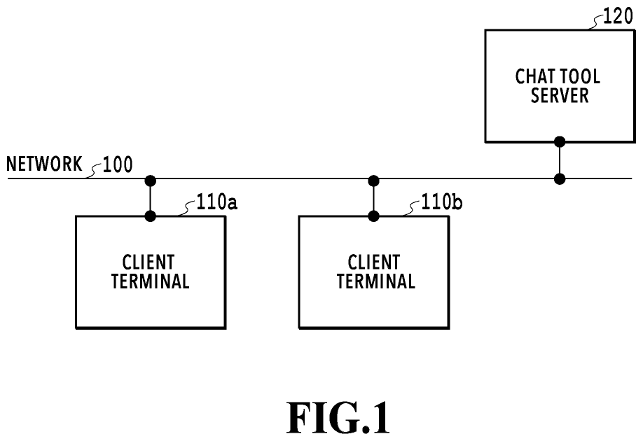

FIG. 1 illustrates an example system configuration according to a first embodiment. More specifically, an Internet environment where client terminals 110a and 110b and a chat tool server 120 are connected by a network 100. For description purposes, only client terminal 110a will be referred to.

The client terminal 110a is an information processing apparatus such as a PC or smartphone. By executing a chat application, the client terminal 110a is in constant communication with other client terminals and a chat tool server 120 via the network 100 and can share a message immediately. The chat tool server 120, which provides a chat service, can communicate with a plurality of client terminals 110a simultaneously and manages chat users and the messages posted by each user.

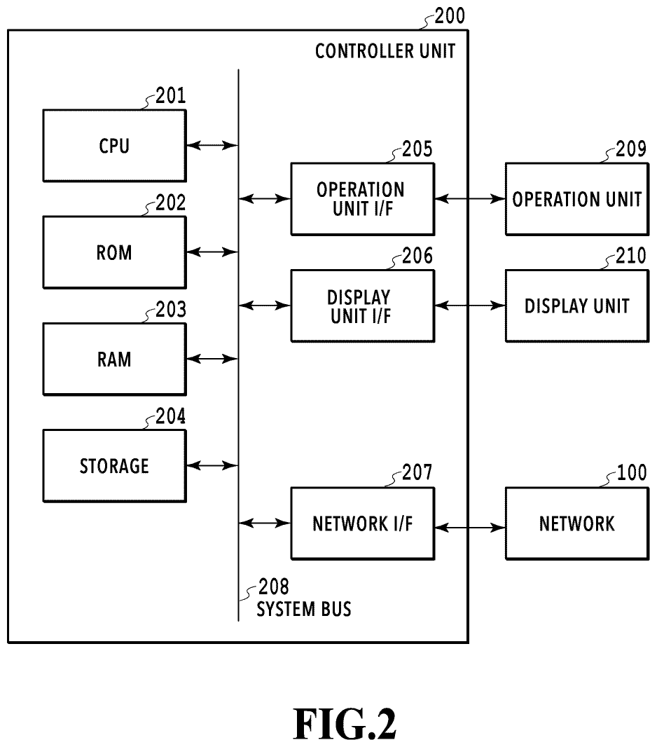

FIG. 2 illustrates an example configuration of an information processing device that can be used as the client terminal 110a and the chat tool server 120. An information processing controller unit 200 is a controller that manages information processing control relating to operations of the client terminal 110a and the chat tool server 120. The information processing controller unit 200 is connected to an operation unit 209 and a display unit 210.

The information processing controller unit 200 has a CPU 201, where the CPU 201 boots an OS with a boot program stored in a ROM 202. The CPU 201 executes an application program stored in a storage 204, thereby performing various processes. The RAM 203 is used as a work area for the CPU 201. The RAM 203 provides a work area and an image memory area for temporary storage of image data.

The storage 204 is an auxiliary storage device such as an SSD or an HDD, which stores the above application programs, image data, and various setting values and histories.

The CPU 201 is connected to an operation unit I/F 205, a display unit I/F 206, and a network I/F 207, along with the ROM 202, the RAM 203, and the storage 204, via a system bus 208.

The operation unit I/F 205 interfaces with the operation unit 209, such as a keyboard and a mouse, and outputs information input by a user via the operation unit 209 to the CPU 201.

The display unit I/F 206 outputs image data to be displayed on a display unit 210. The operation unit 209 and display unit 210 are not required components in the chat tool server 120.

The network I/F 207 is connected to the network 100 and performs information input/output with other client terminals and chat tool server 120 via the network 100.

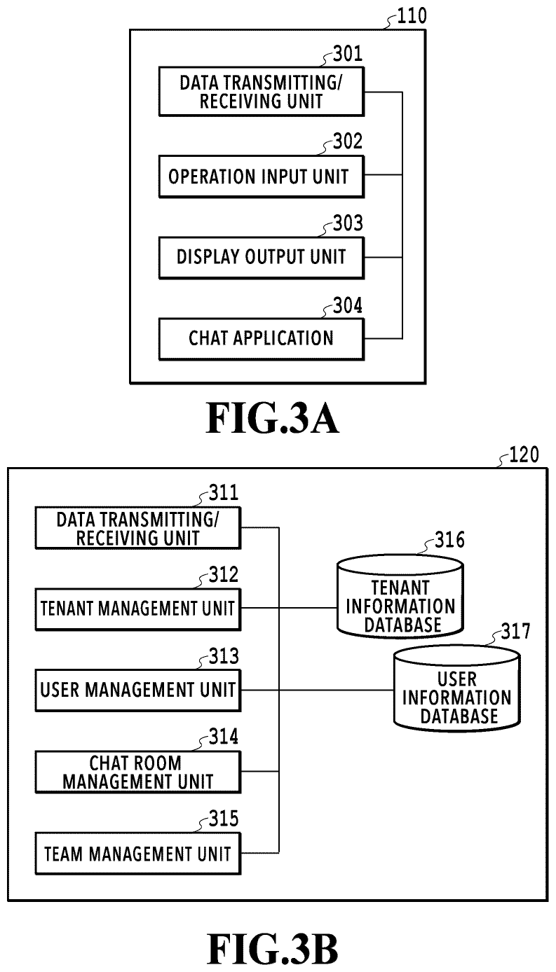

FIG. 3A illustrates an example software configuration of the client terminal 110a. In the present disclosure, these software configurations are realized by the CPU 201 executing a program stored in the ROM 202, RAM 203, or storage 204.

A data transmitting/receiving unit 301 communicates with the chat tool server 120 via the network 100 to transmit requests and receive data. An operation input unit 302 accepts messages and instructions entered by a user from the operation unit 209. A display output unit 303 has a function of displaying various information on the display unit 210. A chat application 304 connects to the chat tool server 120 that provides chat services and has a function of transmitting and receiving messages to the chat tool server 120.

FIG. 3B illustrates an example software configuration of the chat tool server 120. In the present disclosure, these software configurations are realized by the CPU 201 executing a program stored in the ROM 202, RAM 203, or storage 204.

A data transmitting/receiving unit 311 accepts a request for a chat message from the client terminal 110 via the network 100.

A tenant management unit 312 manages information on tenants that define the scope of use for each contracted user, such as corporations and individuals who use the chat tool server 120, in a tenant information database 316. The data stored in the tenant information database 316 is saved in the storage 204.

A user management unit 313 has a function of managing users who use the chat tool server 120. The user management unit 313 manages information such as user IDs, privileges, and the user groups they belong to in a user information database 317. The data stored in the user information database 317 is saved in the storage 204.

A chat room management unit 314 manages a user participating in a chat room created arbitrarily by a user and chat history, etc. The chat history includes message information, including message identification information to identify individual messages, message content, the user who posted the message, and the date and time the message was posted.

A team management unit 315 manages a user who participates in a team, which is a user group created by a user, as well as a thread, a privilege, etc. for each team.

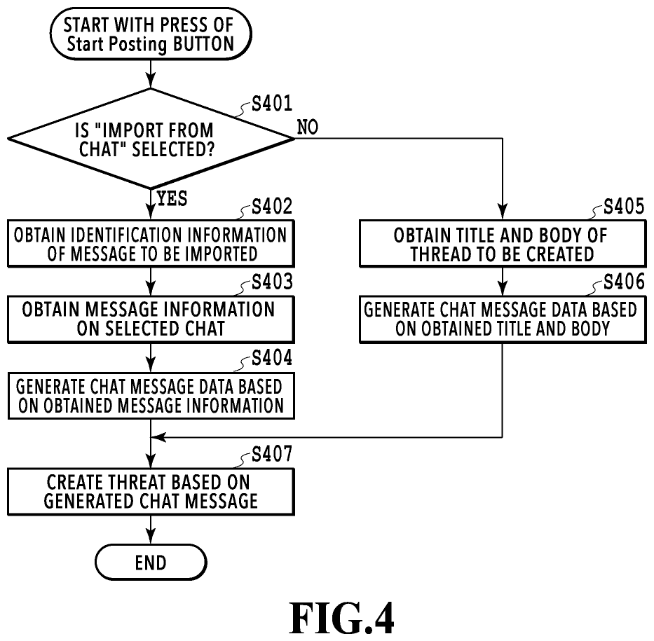

FIG. 4 illustrates a flowchart for a process of creating a new thread. In the present disclosure, the process illustrated in FIG. 4 is implemented by the CPU 201 executing a program stored in the ROM 202, RAM 203, or storage 204.

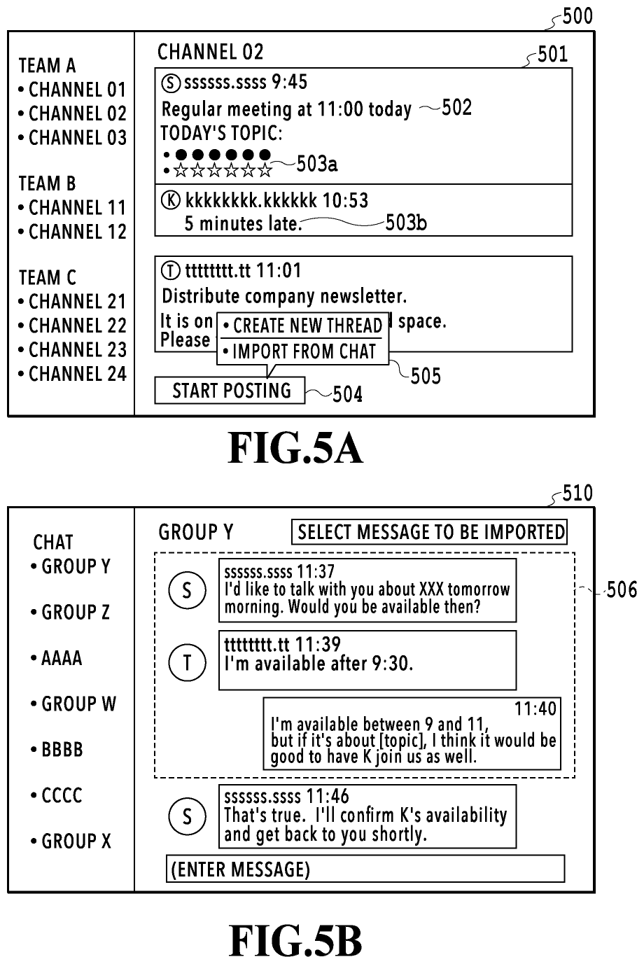

FIGS. 5A and 5B respectively illustrate an example of a channel screen 500 and a chat room screen 510 that are displayed when the chat application is executed on the client terminal 110.

Turning to FIG. 4, in S401, the team management unit 315 determines whether to import a message from the chat history when creating a thread in the channel. Specifically, for example, a pop-up 505 is displayed when a Start Posting button 504 for creating a new thread to be displayed on the channel screen 500 illustrated in FIG. 5A is pressed by a user, and an option is presented to the user. Pop-up 505 presents the user with an option of creating a new thread or importing a message from the chat to create a thread, and determines whether to import a message from the chat history based on the user's selection. If Create New Thread is selected and a message is not imported from the chat history, the process proceeds to S405. If Import from Chat is selected and a message is imported from the chat history, the process proceeds to S402.

In S402, the team management unit 315 obtains from the chat application 304 the message identification information to identify the message selected by the user to import.

Specifically, the chat application 304 displays a list of chats and the history of chats in the selected chat room, in this case “Group Y”, on the chat room screen 510, as, for example, illustrated in FIG. 5B. The chat application 304 then accepts the user's selection of the chat history to be imported, as indicated, for example, by the dashed line 506 by having the user directly specify the message. The team management unit 315 obtains the identification information of the selected message from the chat application 304. The method of making the selection is not limited thereto, and for example, the range of chat history may be specified by date and time. Another chat may be selected from a list of chats on the chat room screen 510 to select another chat history. The team management unit 315 obtains from the chat application 304 the message identification information of the message to be imported selected by the user.

In S403, the team management unit 315 extracts message information corresponding to the message identification information obtained in S402 from the chat history managed by the chat room management unit 314. The message information includes at least the message identification information, the user who posted the message, the date and time of the message posting, and the message content. The message content can include text, images, video, voice messages, etc. The message information can also include read information and an edit/delete flag indicating that the message has been edited or deleted.

In S404, the team management unit 315 generates chat message data based on the message information obtained in S403. The chat message data generated here is specifically the thread message data used to create the thread 501 illustrated in FIG. 5A. In the thread 501 created with this chat message data, the oldest message 503a obtained in S403 is used as the thread body, and the second and later messages 503b are displayed as thread replies. At this time, based on the message information, the user who posted each message can be identified on the created thread, and the messages are displayed in order of posting date and time to reproduce the chat history. In the example illustrated in FIG. 5A, the title 502 of thread 501 is set, but the presence of a title is arbitrary and may be set without a title or with a title specified in any way at the time of import.

The threads created in S404 may be marked to distinguish them from newly created threads without importing messages in S406 below. This enables seeing if messages on a thread have imported messages that have been posted in the past.

In S405, the team management unit 315 obtains the title and body of the thread created from the chat application 304. Specifically, the chat application 304 displays fields on the screen for the user to enter the title and body of the thread, and then waits for the user's input. When the user inputs them, the team management unit 315 obtains the input data.

In S406, the team management unit 315 generates chat message data based on the obtained thread title and body. The chat message data generated here is specifically data to delete a message 503b from a thread 501 illustrated in FIG. 5A and create a thread that contains only a title 502 and a body 503a.

In S407, the team management unit 315 creates a thread displaying a message based on the posting user and posting date/time based on the chat message data obtained in S404 or S406. The processing then ends.

In the presents embodiment, the history of one-on-one individual chats and group chats with three or more people can be imported into a thread, along with message information including the posting user and the date and time of the posting, for a transition to a highly visible thread.

While the target of import has been described with respect to chat, other threads in other channels may also be imported.

### Second Embodiment

While the creation of a new thread is instructed from the team's channel screen according to the first embodiment, the creation of a new thread is instructed from the chat room screen according to a second embodiment.

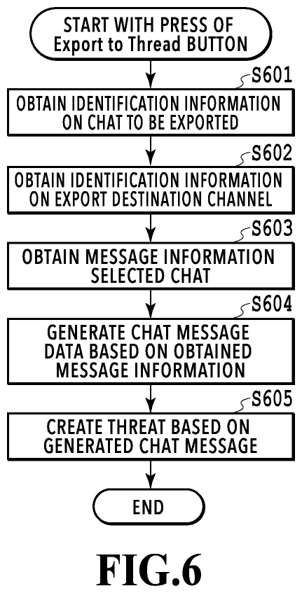

FIG. 6 illustrates a flowchart for a process of creating a new thread according to the present embodiment. In the present disclosure, the process illustrated in FIG. 6 is realized by the CPU 201 executing a program stored in the ROM 202, RAM 203, or storage 204.

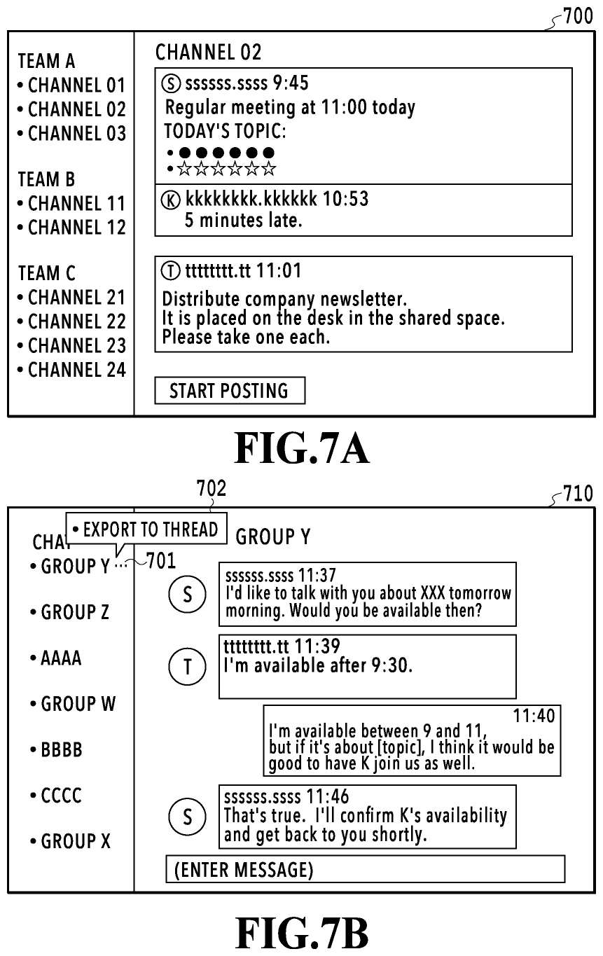

FIGS. 7A and 7B respectively illustrate an example of a channel screen 700 and a chat room screen 710 that are displayed when the chat application is executed on the client terminal 110.

In the chat room screen 710 illustrated in FIG. 7B, a pop-up 702 is displayed when a button 701 for detailed settings provided in each chat is pressed to accept instructions for exporting messages to the thread.

Turning to FIG. 6, in S601, the team management unit 315 obtains from the chat application 304 the chat identification information to identify the chat to be exported selected by the user. Specifically, in response to pressing of the Export to Thread button in pop-up 702, the chat application 304 displays a screen that enables the user to select the chat to be exported and accepts the user's selection. The team management unit 315 obtains the chat identification information of the selected chat from the chat application 304. This is essentially the same as S402, with a difference being that the target individual or group chat is determined in advance and other individual or group chats cannot be selected. In the example illustrated in FIG. 7B, since pop-up 702 is displayed for Group Y, if the Export to Thread button is pressed at this point, only Group Y messages can be selected. To select a message other than those for Group Y, for example, a message in Group Z, it is required to press the button 701 for detail settings for Group Z to display the pop-up 702 and press the Export to Thread button.

In S602, the team management unit 315 obtains from the chat application 304 the channel identification information to identify the export destination channel selected by the user. Specifically, the chat application 304 displays a screen that enables selection of the export destination channel and accepts the user's selection. The team management unit 315 obtains the channel identification information for the selected channel from the chat application 304. The user is prompted to select from the list of teams and channels as illustrated in FIG. 5A so that the identification information of the selected channel is obtained. The export destination may be selected in other directions, as long as the export destination channel is uniquely determined.

In S603, the team management unit 315 obtains message information corresponding to the message identification information of the message included in the chat history obtained in S601 from the chat history managed by the chat room management unit 314. S603 is the same as S403 of the first embodiment.

In S604, the team management unit 315 generates chat message data based on the message information obtained in S603. The chat message data generated here is the same thread message data as in S404 of the first embodiment. The threads created in S604 may be marked to distinguish them from newly created threads without importing messages. This enables seeing if messages on a thread have imported messages that have been posted in the past.

In S605, the team management unit 315 creates a thread with messages displayed based on the posting user and posting date/time based on the chat message data obtained in S604 at the export destination selected in S602. The processing then ends.

The present embodiment enables the history of chats to be moved to a thread while maintaining good visibility from the chat room screen 710 rather than from the channel screen 700.

While the present embodiment discusses a chat as the target of the export, the threads of the channel may also be the target of the export.

### Third Embodiment

In the first and second embodiments, individual chats, group chats, or threads from other channels are imported while maintaining good visibility. In the chat history to be imported, there may be a message from a user who does not belong to the team where the thread to be imported into the chat history is located. If the chat history is imported directly into the thread in that state, a message from a user who does not belong to the team will be present on the thread, which may cause confusion.

Therefore, according to a third embodiment, a user who posts an imported message can identify whether the user belongs to a team.

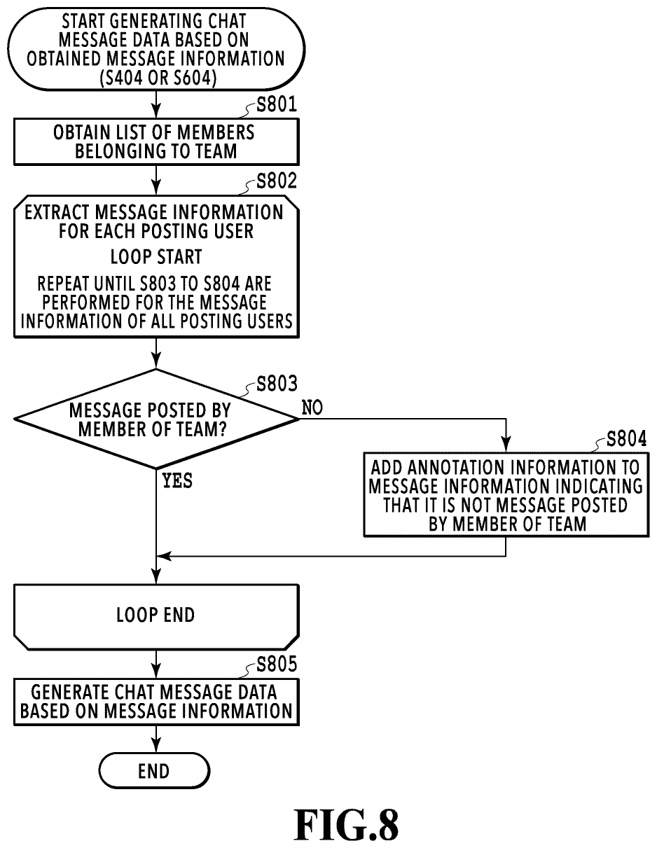

FIG. 8 illustrates a flowchart for a process (S404 or S604) of generating chat message data based on message information according to the present embodiment. In the present disclosure, the process illustrated in FIG. 8 is realized by the CPU 201 executing a program stored in the ROM 202, RAM 203, or storage 204.

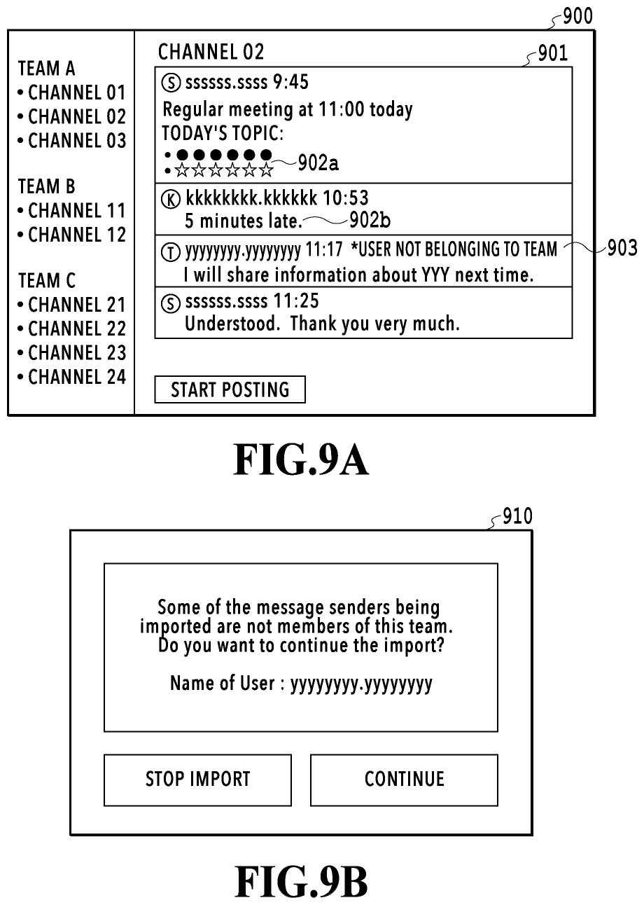

FIG. 9A illustrates an example of a channel screen 900 that is displayed when the chat application is executed on the client terminal 110.

Turning to FIG. 8, in S801, the team management unit 315 obtains a list of members belonging to the team creating a thread. Specifically, the team management unit 315 obtains information on team members managed in the team management unit 315.

In S802, the team management unit 315 extracts message information for each posting user from the message information obtained in S403 and S603. Specifically, S803 to S804 are performed by extracting the message information of one posting user, and repeated until S803 to S804 are performed for the message information of all posting users.

In S803, the team management unit 315 determines whether the user posting the extracted message information is a member of the team. Specifically, the posting user included in the message information is compared with the list of members obtained in S801. If it is determined that the user posting the message information is a member of the team, the process returns to S802 and repeats S803 for the next posting user's message information. If it is determined that the user posting the message information is not a member of the team, the process moves to S804.

In S804, the team management unit 315 adds annotation information to the message information indicating that it is not a member of the team. Specifically, an annotation 903 may be added as illustrated in FIG. 9A. Other symbols may be used for the distinction. A confirmation screen 910, as illustrated in FIG. 9B, for example, may be displayed immediately before S804.

S803 and S804 are repeated for all posting users to check whether annotations are required for all message information.

In S805, the team management unit 315 generates, based on the message information that has been confirmed whether requiring annotation, chat message data in the same way as in S404 and S604. With respect to the chat message data generated here, message information including annotation information is data to be used to create the channel screen 900 illustrated in FIG. 9A. Messages corresponding to message information that includes annotation information have annotation 903 displayed in association with the message on the channel screen 900.

The present embodiment enables identification of whether the user posting the imported message belongs to a team when importing a message from an individual chat, group chat, or thread on a different channel. This enables users on the team to check the message history of a thread without confusion.

### Fourth Embodiment

The first to third embodiments enable importing selected chats and threads as threads of an arbitrary channel. In some chats and threads, there may be messages that are not wanted to be shared with anyone other than the members participating in the chat or thread for reasons such as confidential information. Therefore, according to a fourth embodiment, when attempting to import chats or threads, the import is restricted if the message to be imported contains information that the user does not want to share.

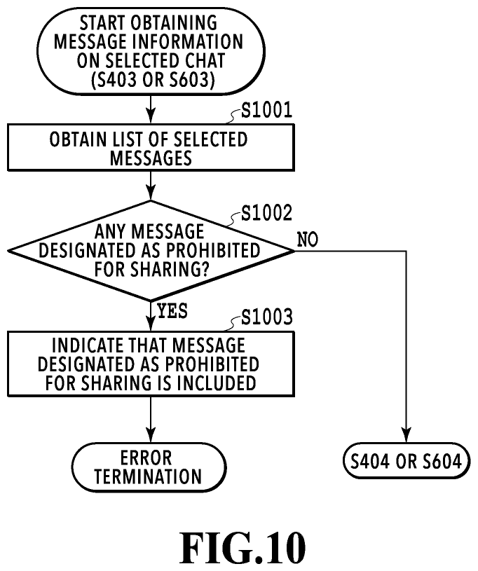

FIG. 10 illustrates a flowchart for a process of obtaining message information on the selected chat (S403 or S603). In the present disclosure, the process illustrated in FIG. 10 is realized by the CPU 201 executing a program stored in the ROM 202, RAM 203, or storage 204.

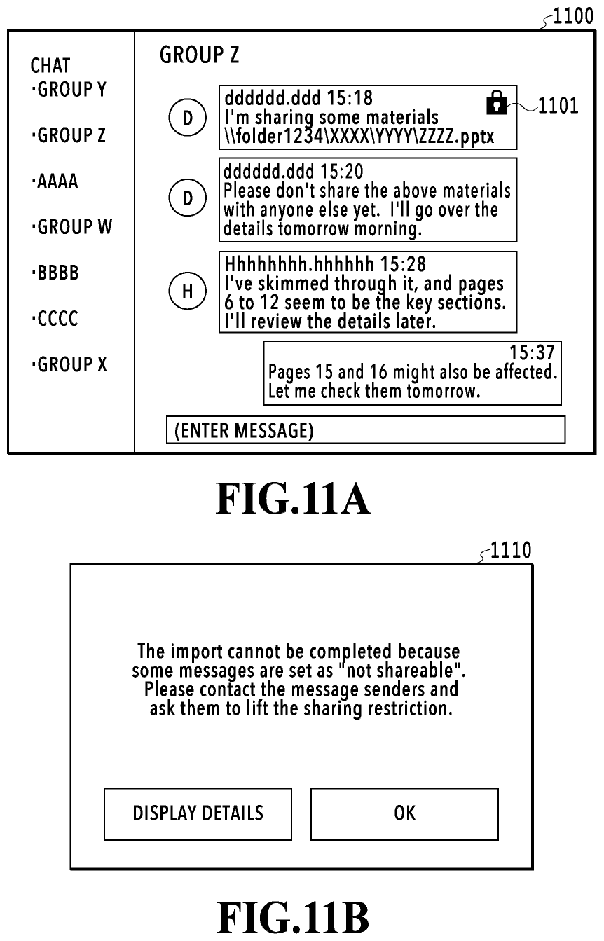

FIGS. 11A and 11B illustrate an example of a chat room screen that is displayed when a chat application is executed on the client terminal 110.

Turning to FIG. 10, in S1001, the team management unit 315 obtains a list of selected messages.

The message information includes the user who posted a message, the date and time the message was posted, the message content, and the sharing information that specifies whether sharing is permitted or prohibited.

In S1002, the team management unit 315 determines whether there are any messages designated as prohibited for sharing in the message information. Specifically, when posting a message, the chat application 304 accepts the sharing information of that message from the user and includes the accepted sharing information in the message information. A message for which the prohibition of sharing is specified in the sharing information, for example, displays a symbol 1101 indicating the prohibition of sharing in association with the message on the chat room screen 1100 illustrated in FIG. 11A. The team management unit 315 refers to this sharing information to determine whether there is even one message that is set to prohibited sharing. If there is at least one message designated as prohibited for sharing among the messages to be imported, the process proceeds to S1003. If there is no message designated as prohibited for sharing, the process proceeds to the next process (S404 or S604). The shared information does not have to be on a per-message basis, but may be specified, for example, on a per-chat, per-thread or per-user basis.

In S1003, the team management unit 315 displays a pop-up screen 1110 as illustrated in FIG. 11B on the chat application 304. When the OK button is pressed, the import process ends as an error termination.

According to the present embodiment, if there is a message containing confidential information or other information that is not to be shared with anyone other than the members of the team, the confidentiality can be protected by restricting the export of the chat history of that group to other threads without permission.

The present disclosure enables users to select messages arbitrarily from those posted to the chat service and display them together in a highly visible manner.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-227348, filed Dec. 24, 2024, which is hereby incorporated by reference herein in its entirety.

What is claimed is:

1. A non-transitory computer readable storage medium storing a computer program that executes a method, the method comprising:
receiving a selection of a channel to which a message written in a chat is to be transferred; and
displaying, on a screen of the selected channel, the message transferred to the selected channel,
wherein, on the screen of the channel on which the transferred message is displayed, an object by which the message is identifiable as a transferred message is displayed.

2. The non-transitory computer readable storage medium according to claim 1, wherein
the channel is a space for having conversations within a team, and
the chat is a space for having conversations independently of any team or channel.

3. The non-transitory computer readable storage medium according to claim 2, wherein channels are grouped by each team.

4. The non-transitory computer readable storage medium according to claim 1, wherein the chat includes a chat among at least three users.

5. The non-transitory computer readable storage medium according to claim 1, wherein the object is displayed in association with the transferred message.

6. The non-transitory computer readable storage medium according to claim 1, wherein the message to be transferred is a message selected from messages written in the chat.

7. The non-transitory computer readable storage medium according to claim 1, wherein the transferred message is displayed as a thread on the screen of the channel.

8. A non-transitory computer readable storage medium storing a computer program that executes a method, the method comprising:
receiving a selection of a channel to which a message written in a chat is to be transferred; and
displaying, on a screen of the selected channel, the message transferred to the selected channel,
wherein, on the screen of the channel on which the transferred message is displayed, an object signifying that the message is a transferred message is displayed.

9. The non-transitory computer readable storage medium according to claim 8, wherein
the channel is a space for having conversations within a team, and
the chat is a space for having conversations independently of any team or channel.

10. The non-transitory computer readable storage medium according to claim 9, wherein channels are grouped by each team.

11. The non-transitory computer readable storage medium according to claim 8, wherein the chat includes a chat among at least three users.

12. The non-transitory computer readable storage medium according to claim 8, wherein the object is displayed in association with the transferred message.

13. The non-transitory computer readable storage medium according to claim 8, wherein the message to be transferred is a message selected from messages written in the chat.

14. The non-transitory computer readable storage medium according to claim 8, wherein the transferred message is displayed as a thread on the screen of the channel.

15. An information processing apparatus, comprising:
at least one memory that stores a program; and
at least one processor that executes the program to perform:
receiving a selection of a channel to which a message written in a chat is to be transferred; and
displaying, on a screen of the selected channel, the message transferred to the selected channel,
wherein, on the screen of the channel on which the transferred message is displayed, an object by which the message is identifiable as a transferred message is displayed.

16. The information processing apparatus according to claim 15, wherein
the channel is a space for having conversations within a team, and
the chat is a space for having conversations independently of any team or channel.

17. The information processing apparatus according to claim 16, wherein
channels are grouped by each team.

18. The information processing apparatus according to claim 15, wherein the chat includes a chat among at least three users.

19. The information processing apparatus according to claim 15, wherein the object is displayed in association with the transferred message.

20. The information processing apparatus according to claim 15, wherein the message to be transferred is a message selected from messages written in the chat.

21. The information processing apparatus according to claim 15, wherein the transferred message is displayed as a thread on the screen of the channel.

22. An information processing apparatus, comprising:
at least one memory that stores a program; and
at least one processor that executes the program to perform:
receiving a selection of a channel to which a message written in a chat is to be transferred; and
displaying, on a screen of the selected channel, the message transferred to the selected channel,
wherein, on the screen of the channel on which the transferred message is displayed, an object signifying that the message is a transferred message is displayed.

23. The information processing apparatus according to claim 22, wherein
the channel is a space for having conversations within a team, and
the chat is a space for having conversations independently of any team or channel.

24. The information processing apparatus according to claim 23, wherein
channels are grouped by each team.

25. The information processing apparatus according to claim 22, wherein the chat includes a chat among at least three users.

26. The information processing apparatus according to claim 22, wherein the object is displayed in association with the transferred message.

27. The information processing apparatus according to claim 22, wherein the message to be transferred is a message selected from messages written in the chat.

28. The information processing apparatus according to claim 22, wherein the transferred message is displayed as a thread on the screen of the channel.

29. An information processing method comprising:
receiving a selection of a channel to which a message written in a chat is to be transferred; and
displaying, on a screen of the selected channel, the message transferred to the selected channel,
wherein, on the screen of the channel on which the transferred message is displayed, an object by which the message is identifiable as a transferred message is displayed.

30. The information processing method according to claim 29, wherein
the channel is a space for having conversations within a team, and
the chat is a space for having conversations independently of any team or channel.

31. The information processing method according to claim 30, wherein
channels are grouped by each team.

32. The information processing method according to claim 29, wherein the chat includes a chat among at least three users.

33. The information processing method according to claim 29, wherein the object is displayed in association with the transferred message.

34. The information processing method according to claim 29, wherein the message to be transferred is a message selected from messages written in the chat.

35. The information processing method according to claim 29, wherein the transferred message is displayed as a thread on the screen of the channel.

36. An information processing method comprising:
receiving a selection of a channel to which a message written in a chat is to be transferred; and
displaying, on a screen of the selected channel, the message transferred to the selected channel,
wherein, on the screen of the channel on which the transferred message is displayed, an object signifying that the message is a transferred message is displayed.

37. The information processing method according to claim 36, wherein
the channel is a space for having conversations within a team, and
the chat is a space for having conversations independently of any team or channel.

38. The information processing method according to claim 37, wherein
channels are grouped by each team.

39. The information processing method according to claim 36, wherein the chat includes a chat among at least three users.

40. The information processing method according to claim 36, wherein the object is displayed in association with the transferred message.

41. The information processing method according to claim 36, wherein the message to be transferred is a message selected from messages written in the chat.

42. The information processing method according to claim 36, wherein the transferred message is displayed as a thread on the screen of the channel.
